(19) United States
(12) Patent Application Publication
(10) Pub. No.: US 2005/0149970 A1
(43) Pub. Date: Jul. 7, 2005

(54) Method and apparatus for synchronization of plural media streams

(76) Inventors: Jon A. Fairhurst, Camas, WA (US); Henry Y. Fang, Cerritos, CA (US); Bryan S. Hallberg, Vancouver, WA (US); Mark G. Hanley, Skamania, WA (US); Vishnu Kumar Shivaj Rao, Vancouver, WA (US); Jeffrey B. Sampsell, San Francisco, CA (US)

Correspondence Address: MARGER JOHNSON & MCCOLLOM, P.C. - SHARP, 1030 SW MORRISON STREET, PORTLAND, OR, 97205, US

(21) Appl. No.: 10/976,498

(22) Filed: Oct. 29, 2004

Related U.S. Application Data
(60) Provisional application No. 60/535,117, filed on Jan. 6, 2004.

(51) Int. Cl. G06F 3/00; H04N 5/445; G06F 13/00

(52) U.S. Cl. 725/47

(57) ABSTRACT

Embodiments of the invention provide a method and apparatus for synchronizing multiple media streams to conveniently produce multimedia presentations using a television system. Some embodiments of the invention may provide a slideshow application, a karaoke application, or a storybook application.

### CROSS REFERENCE TO RELATED APPLICATIONS

This application claims priority from U.S. Provisional Patent Application 60/535,117, filed on 6 Jan. 2004, which is incorporated by reference in its entirety for all purposes.

### BACKGROUND OF THE INVENTION

1. Technical Field of the Invention

This disclosure relates in general to television systems, and more particularly to a method and apparatus that allows a television system to synchronize multiple audio and video data streams.

2. Description of the Related Art

As embedded computers in televisions become more capable, it is inevitable that these computers will be called upon to perform a variety of functions that have typically required separate and distinct systems. Whereas the first applications on computers embedded in televisions processed user input in managing TV settings (traditional menu and on-screen display, or OSD), future applications will mimic the much broader base of functionality found in today's personal computers (PCs).

One area in which conventional television systems are currently deficient is the creation and playback of multimedia presentations. Although PCs presently allow a user to create slideshows with digital images, these slideshows are typically intended to be accompanied by a speech or briefing that is performed by a human presenter. Furthermore, in order for many people to conveniently view the slideshow, the PC video output must either be sent as input to a separate projection device or to a television system. The first option is not available to most consumers, since projection devices are not common in most households. The second option is inconvenient because the PC is not typically attached to the television system at all times.

Additional problems are encountered if a musical soundtrack is desired to accompany the slideshow, especially in a household setting. Digital audio editing capability is currently provided by PCs, but synchronizing the soundtrack to the slideshow presentation is a laborious and cumbersome process because the video and audio editing are done in separate applications. Other inconveniences exist because the audio soundtrack must typically be sent to another system for playback but the playback itself is controlled from the PC.

Embodiments of the invention address these and other limitations of the conventional art.

### BRIEF DESCRIPTION OF THE SEVERAL VIEWS OF THE DRAWINGS

The foregoing and other objects, features and advantages of the invention will become more readily apparent from the following detailed description of several preferred embodiments of the invention that proceeds with reference to the accompanying drawings.

FIG. 1 is a block diagram illustrating a possible operating environment for some embodiments of the invention.

FIG. 2 is a block diagram illustrating an example television capable of operating according to some embodiments of the invention.

FIG. 3 illustrates a slideshow selection screen according to some embodiments of the invention.

FIG. 4 illustrates a slideshow creation screen according to some embodiments of the invention.

FIG. 5 illustrates a slide sorting screen according to some embodiments of the invention.

FIG. 6 illustrates a fullscreen slideshow mode of operation according to some embodiments of the invention.

FIG. 7 illustrates a manual slideshow mode of operation according to some embodiments of the invention.

### DETAILED DESCRIPTION OF THE INVENTION

Several preferred embodiments of the invention will now be described with reference to the several views of the drawings. The embodiments described below are not intended to be a complete or exhaustive list of all embodiments of the invention, rather they are used to help explain and elucidate the inventive concepts embraced by embodiments of the invention. It will be recognized that various modifications may be made to the exemplary embodiments described herein yet the modifications will still retain the inventive concepts.

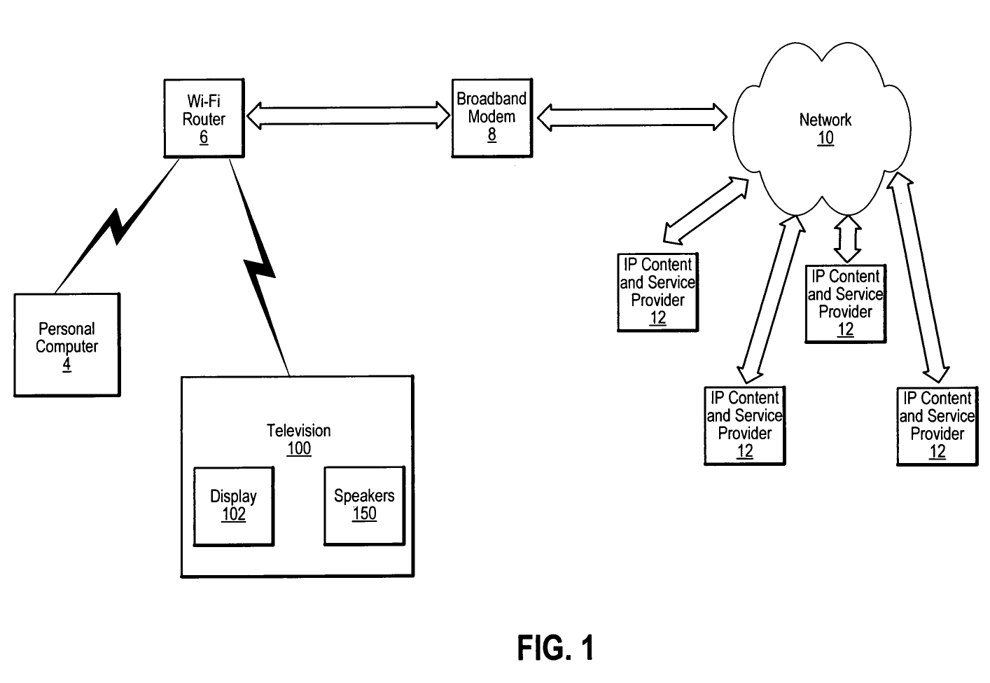

FIG. 1 is a block diagram illustrating an example operating environment for some embodiments of the invention. Television system 100 and personal computer 4 may be wirelessly connected to a Wi-Fi (wireless fidelity) router 6. Wi-Fi is used generically to refer to any wireless network including, but not limited to, an IEEE 802.11 network. For example, a Wi-Fi network may include those defined by the basic IEEE 802.11 specification or extensions to the basic specification such as IEEE 802.11a, IEEE 802.11b, or IEEE 802.11g.

The Wi-Fi router 6 is connected, in turn, to a broadband modem 8, which may be, e.g., a cable modem. Broadband modem 8 provides a connection to a network 10. Network 10 may be, for example, the internet or world wide web. The network 10 may be connected, in turn, to a number of IP Content and Service Providers 12.

In the operating environment illustrated in FIG. 1, in addition to outputting television broadcasts, the television system 100 may be able to output content received from the personal computer 4 or from the IP Content and Service Providers 12. For example, popular applications for personal computers include gaming, editing digital image files such as JPEGs (Joint Photographic Experts Group), editing and/or listening to digital audio files such as MP3s (Moving Picture Experts Group, Audio Layer 3) or WMAs (Windows Media Audio), and editing and/or playing digital video. In the operating environment illustrated in FIG. 1, the personal computer 4 may provide this content to the television system 100 for playback. In other words, digital photos may be displayed on the television system 100 and digital audio and/or digital video may be streamed from the PC for playback on the audio and/or display subsystems of television system 100.

The television system 100 may also output content provided from the numerous IP content and service providers 12 by virtue of its connection to the network 8. For example, the user of the personal computer 4 would normally listen to and/or view content from the IP content and service provider 12 with the monitor (not shown) or the speakers (not shown) that are part of the personal computer 4. However, in this operating environment the user may also listen to and/or view the same audio and/or video content received over the network 8 using the display 102 and speakers 150 of the television system 100.

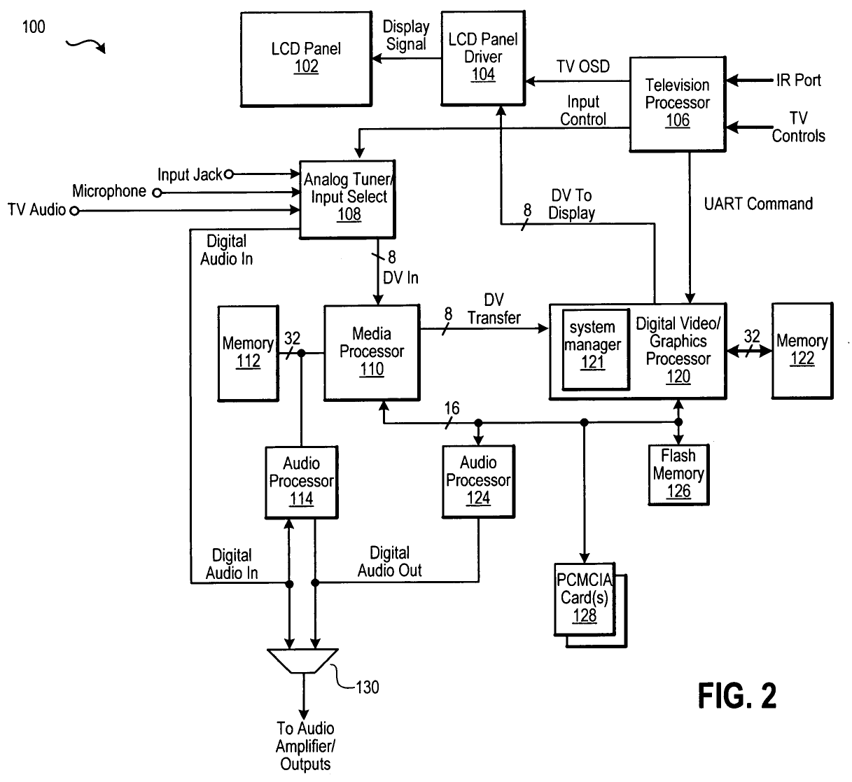

FIG. 2 is a block diagram illustrating an example television system 100 capable of operating according to some embodiments of the invention. In this example, television system 100 is a Liquid Crystal Display (LCD) television. The television system 100 contains an LCD panel 102 that displays visual output to a viewer based on a display signal generated by an LCD panel driver 104. LCD panel driver 104 accepts a primary digital video signal in CCIR656 format (eight bits per pixel YC_{b}Cᵣ, in a “4:2:2” data ratio wherein two C_{b} and two Cᵣ pixels are supplied for every four luminance pixels) from a digital video/graphics processor 120.

A television processor 106 provides basic control functions and viewer input interfaces for television system 100. Television processor 106 receives viewer commands, both from buttons located on the television itself (TV controls) and from a handheld remote control unit (not shown) through the IR Port. Based on the viewer commands, television processor 106 controls an analog tuner/input selector 108, and also supplies user inputs to a digital video/graphics processor 120 over a Universal Asynchronous Receiver/Transmitter (UART) command channel. Television processor 106 is also capable of generating basic On-Screen Display (OSD) graphics, e.g., graphics that indicate the currently selected input source, the current audio volume setting, etc. Television processor 106 supplies these OSD graphics as a TV OSD signal to LCD panel driver 104 for overlay on the display signal.

Analog tuner/input selector 108 allows television system 100 to switch between various analog (or possibly digital) inputs for both video and audio. Although not shown in FIG. 2, the video inputs may include a radio frequency (RF) signal carrying broadcast television, digital television, and/or high-definition television signals, NTSC video, S-Video, and/or RGB component video inputs, although various embodiments may not accept each of these signal types or may accept signals in other formats (such as PAL). The selected video input is converted to a digital data stream, DV In, in CCIR656 format and supplied to a media processor 110.

Analog tuner/input selector 108 also selects an audio source, digitizes that source (if necessary) using an internal A/D converter (not shown), and supplies that digitized source as Digital Audio In to an Audio Processor 114 and a multiplexer 130. Digitization of the source may not be necessary if it is already supplied to the analog tuner/input selector 108 in digital form.

The audio source may be selected—independent of the current video source—as the audio channel(s) of a currently tuned RF television signal, stereophonic or monophonic audio connected to television system 100 by audio jacks corresponding to a video input, or an internal microphone. These audio sources are represented in FIG. 2 by TV Audio, Input Jack, and Microphone, respectively. Since the microphone typically has a relatively low signal amplitude, the output of the microphone is usually passed through an amplifier stage (not shown) before being sent to the source selection switch (not shown) in the analog tuner/input select section 108.

Media processor 110 and digital video/graphics processor 120 provide various digital feature capabilities for television system 100. In some embodiments, processors 110 and 120 can be TMS320DM270 signal processors, available from Texas Instruments, Inc., Dallas, Tex. Digital video/graphics processor 120 functions as a master processor, and media processor 110 functions as a slave processor. Digital video/graphics processor 120 includes the system manager 121, which will be explained in further detail below. Media processor 110 supplies digital video, either corresponding to DV In or to a decoded media stream from another source, to digital video/graphics processor 120 over a DV transfer bus.

Media processor 110 may perform MPEG (Moving Picture Experts Group) coding and decoding of digital media streams for television system 100, as instructed by digital video/graphics processor 120. A 32-bit-wide data bus connects memory 112, e.g., two 16-bit-wide×1M synchronous Dynamic Random Access Memory (DRAM) devices connected in parallel, to processor 110. The audio processor 114 is also connected to this data bus to provide audio coding and decoding for media streams handled by media processor 110.

Digital video/graphics processor 120 coordinates (and/or implements) many of the digital features of television system 100. A 32-bit-wide data bus connects memory 122, e.g., two 16-bit-wide×1M synchronous DRAM devices connected in parallel, to processor 120.

Although the embodiments of the invention shown in FIG. 2 utilize DRAM memory devices, other embodiments of the invention may be implemented with other memory types, for example, synchronous dynamic random access memory (SDRAM) devices. Furthermore, memory 112 and memory 122 need not be volatile memory. For example, alternative embodiments of the invention may be implemented using static random access memory (SRAM). Other embodiments of the invention may not even utilize silicon-based memory. For example, alternative embodiments of the invention may be implemented with disk-based technology or any other storage technology.

A 16-bit-wide system bus connects processor 120 to media processor 110, an audio processor 124, flash memory 126, and removable PCMCIA (Personal Computer Memory Card International Association) cards 128. Flash memory 126 stores boot code, configuration data, executable code, and Java code for graphics applications, etc. PCMCIA cards 128 can provide extended media and/or application capability. Digital video/graphics processor 120 can pass data from the DV Transfer bus to the LCD panel driver 104 directly without being changed, but processor 120 can also supercede, modify, or superimpose the DV Transfer signal with other content.

Multiplexer 130 provides audio output to the television amplifier and line outputs (not shown) from one of three sources. The first source is the current Digital Audio In stream from analog tuner/input selector 108. The second and third sources are the Digital Audio Outputs of audio processors 114 and 124. These outputs of audio processors 114 and 124 are tied to the same input of multiplexer 130, since each audio processor is capable of tri-stating its output when it is not selected. In some embodiments, processors 114 and 124 can be TMS320VC5416 signal processors, available from Texas Instruments, Inc., Dallas, Tex.

In the embodiments illustrated in FIG. 2, a system manager 121 resides on the digital video/graphics processor 120. The system manager 121 is responsible for the basic operation of television system 100, including locating and extracting various applet files upon user request. The applets may be stored for retrieval by the system manager 121 in various memory systems of television system 100, including memory 112 and 122, flash memory 126, or on PCMCIA cards 128.

The system manager 121 and associated graphic user interface, operable on television system 100, functions to present the user with all possible user selectable programs that the user may run, and enable the user to navigate through the programs and select and run their desired program. The user may also sort the program icons so that their favorite program icons are displayed first, allowing quick access to the user's favorite programs.

Embodiments of the invention provide the user with the ability to create, edit, and playback multimedia presentations using a television system such as the television system 100 of FIG. 2. Because the television system 100 can access digital image, digital audio, and digital video files stored on network devices (such as PC 4 in FIG. 1), the user of television system 100 may create, edit, and playback multimedia presentations directly on television system 100 without having to run separate audio and image editing applications on PC 4.

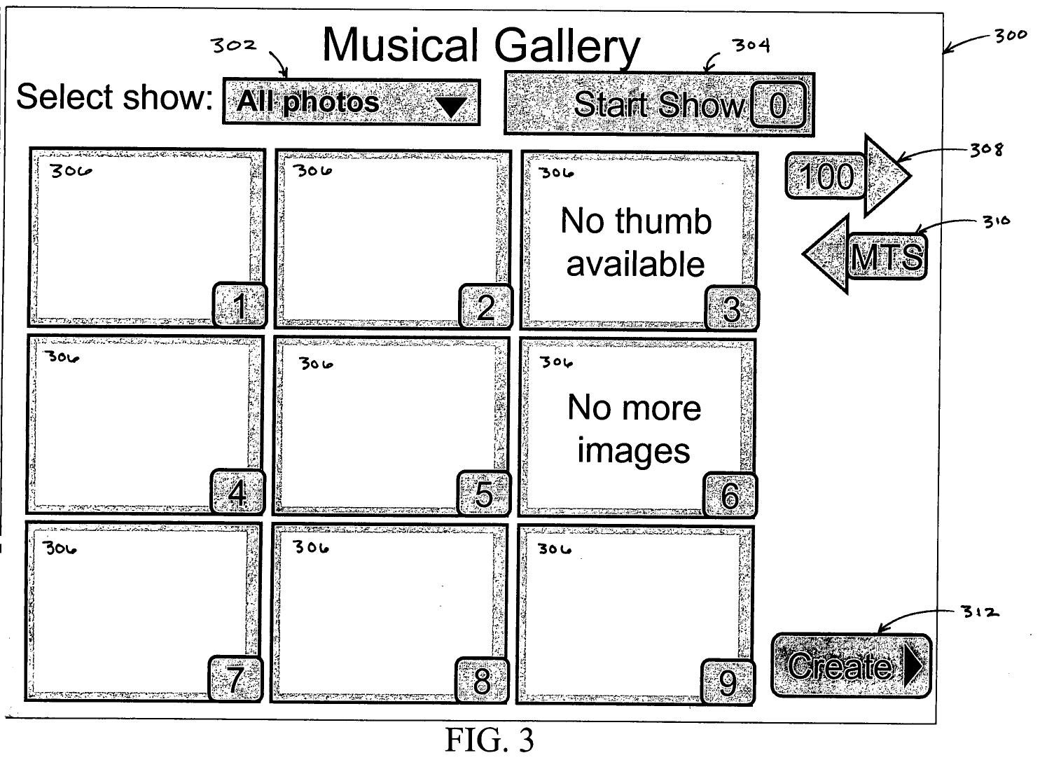

Some embodiments of the invention will now be explained with reference to FIGS. 3-7, which are examples of video output displayed to the user on the LCD panel 102 of FIG. 2.

FIG. 3 illustrates a slideshow selection screen 300 according to some embodiments of the invention. Using the remote control for television system 100, the user of television system 100 can key the appropriate selection keys to arrive at the slideshow selection screen 300. Once there, the user may make further selections to create, edit, or playback a multimedia presentation.

The options illustrated in FIG. 3 may be selected by keying touch pads or switches on a television remote control or on a television control panel. These touch pads and switches may correspond to numbers, arrow keys, and enter or select functions on the television remote control or control panel. Arrow keys may be used to position a cursor on the desired option and then the option may be selected by triggering the enter or the select key. Similarly, some options may be selected directly by depressing the corresponding number key on the remote control or control panel, or by depressing a series of number keys, e.g., 100.

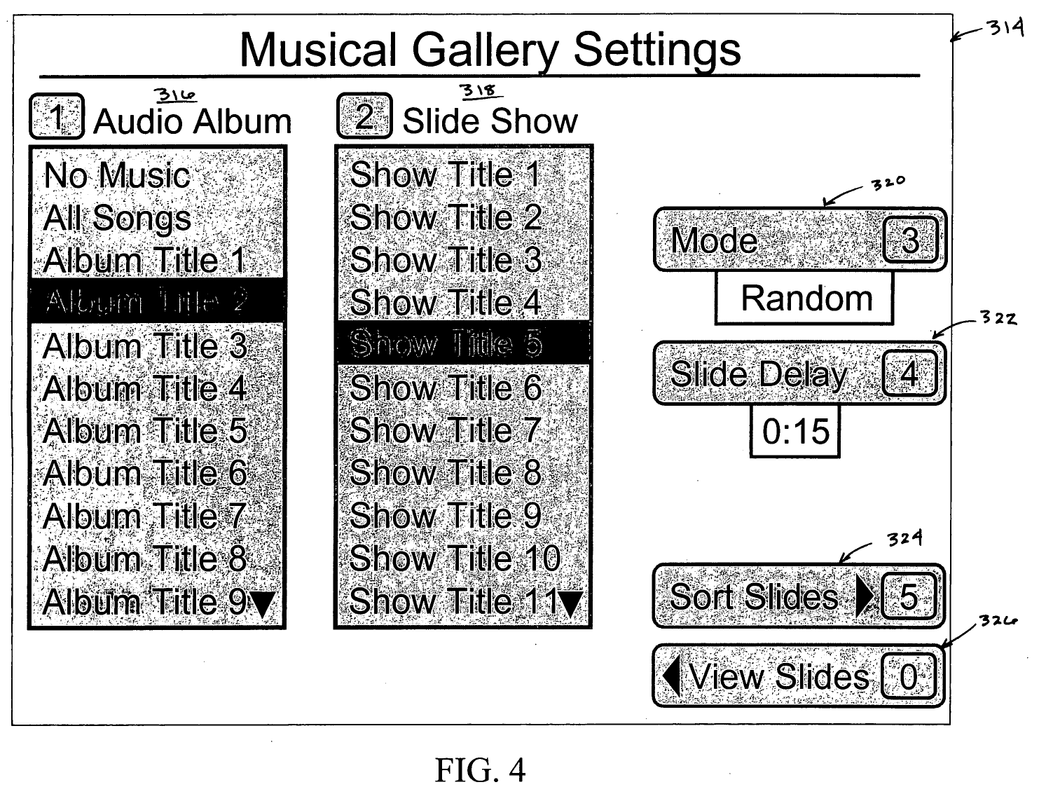

The selection processes describe above are merely examples and are familiar to most users of television systems. The selection processes described above also frequently reoccur in the description of FIGS. 4-7 below. Consequently, when the terms “selected” or “chosen” are used below in association with FIGS. 4-7, it will be understood what those terms may mean, without having to unnecessarily explain the operation of a television remote control or a television control panel.

With reference to FIG. 3, the dropdown menu 302 allows the user to view all the images that are available to the user. These images may include the digital image files (such as .gif, .tif, .bmp, and .jpg files) stored in other network devices connected to the television system 100, such as the PC 4 of FIG. 1. Although not illustrated in FIG. 3, the dropdown menu 302 can also display the titles of other previously created slideshows.

Depending on the particular slideshow that is eventually selected in the dropdown menu 302, each image box 306 may contain one of the images of the selected slideshow, or one out of all the available images. If there are more images in the selected slideshow than there are image boxes 306 available on the slide selection screen 300, then some embodiments of the invention may also provide options to the user of television system 100 that enable the user to selectively scroll through all of the images.

When the user of television system 100 selects an individual image box 306, the image may be displayed in an enlarged format, such as full-screen, for the user. If an image cannot be displayed in the image box 306, a message may be displayed, such as the one shown in the image box 306 corresponding to numeral 3. The end of the slideshow may also be indicated by a message, such as the one shown in the image box 306 that corresponds to numeral 6.

Selection screen 300 also includes a start option 304 that, when selected, causes the television system 100 to initiate the slideshow indicated by dropdown menu 302. Selection screen 300 also includes a “page forward” option 308 and a “page back” option 310. The numeral “100” associated with the “page forward” option 308 indicates to the user of television system that the button on the TV remote control marked “100” must be pressed to activate the “page forward” function. The triangle symbol associated with the “page forward” option 308 may also remind the user in which direction the “page forward” option 308 serves to move the images in the image boxes 306. The characters “MTS” associated with the “page back” option 310 indicates to the user of the television system that the button on the TV remote control marked “MTS” must be pressed to activate the “page back” function. The triangle symbol associated with the “page back” option 310 may also remind the user in which direction the “page back” option moves the images in image boxes 306. Using the “page back” option 310 and “page forward” option 308, the user of television system 100 may quickly scroll through all the images in a particular slideshow. Alternative embodiments of the invention may use other buttons on the remote control or on the television control panel to implement the “page back” and “page forward” options. Furthermore, alternative embodiments of the invention may have other image manipulation options available.

Lastly, selection screen 300 includes a create option 312 that, when selected, causes the LCD panel 102 of television system 100 to output a slideshow creation screen, which will be explained further below in conjunction with FIG. 4.

FIG. 4 illustrates a slideshow creation screen 314 according to some embodiments of the invention. The slideshow creation screen 314 includes an audio album menu 316 and a slide show menu 318. By choosing the desired slideshow using the slide show menu 318, the user of television system 100 may associate with the selected slide show a desired musical accompaniment using the audio album menu 316. Although not shown in FIG. 4, some embodiments of the invention may also include an option in the slide show menu 318 entitled “new slideshow.” Selecting this option would allow the user of television system 100 to enter the name of an entirely new slideshow presentation. The user could then associate images and audio with the new slideshow using features that will be explained below.

In the options shown in FIG. 4, selecting the option “All Songs” may cause the entire list of digital audio files to be displayed in the audio album menu 316. At that point the user of television system 100 could select from among all the available digital audio files or choose to have all the available digital audio files associated with the selected slideshow.

If the user of the television system 100 chose one of the album titles displayed in the audio album menu 316, the digital audio files composing the selected audio album may be displayed. At that point the user of television system 100 could select from among the individual digital audio files composing the selected album or choose to have all songs in the selected album associated with the selected slideshow.

It should be recognized that embodiments of the invention are not limited only to associating music with selected slideshows. Digital audio files may include other sounds that are not considered musical per se, such as human voices, animal calls, bird songs, mechanical noises, sound effects, etc.

The slideshow creation screen 314 also includes a mode option 320, that when selected, toggles between the possible modes of the slideshow presentation. In FIG. 4, a random mode that causes the images in the slideshow to be randomly displayed is illustrated. Other possible modes may include a normal (sequential) mode, and a repeat mode that causes the slideshow to playback in a continuous loop.

The slideshow creation screen 314 also includes a slide delay option 322, that when selected, allows the user of television system 100 to input the amount of time that each individual image in the selected slideshow is displayed on the LCD screen 102.

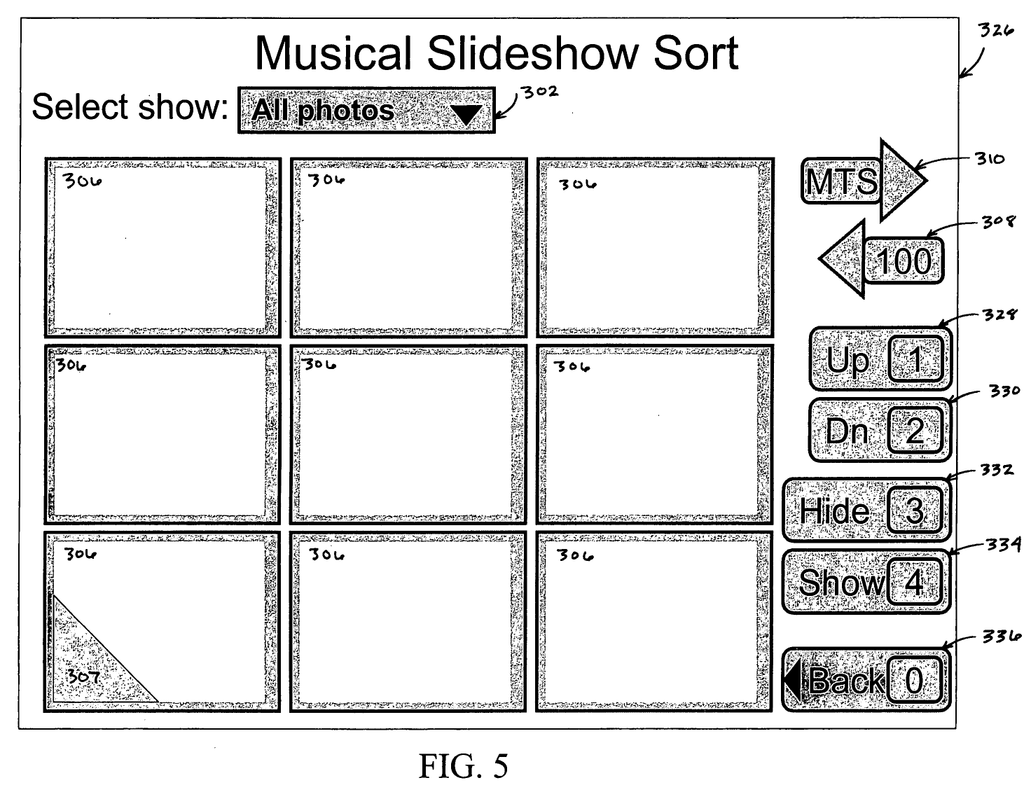

Also included in the slideshow creation screen 314 is a slide sorting option 324 and a slide viewing option 326. When the slide sorting option 324 is selected, the television system 100 causes the LCD panel 102 to display a slide sorting screen, which will be explained further below in conjunction with FIG. 5. When the slide viewing option 326 is selected, the television system causes the LCD panel 102 to return to the slideshow selection screen 300 of FIG. 3.

FIG. 5 illustrates a slide sorting screen 326 according to some embodiments of the invention. Like the slideshow selection screen 300 of FIG. 3, the slide sorting screen 326 includes a dropdown menu 302, a page back option 308, and a page forward option 310, all of which have substantially the same function as explained above with respect to FIG. 3. The slide sorting screen also includes a number of image boxes 306, each image box displaying one of the digital images in the slideshow selected by the dropdown menu 302.

The slide sorting screen 326 allows the user of television system 100 to change the order of appearance of the individual images in the selected slideshow. Once the desired image in the corresponding image box 306 has been selected, the user may manipulate the placement of the selected image with the options illustrated on the right side of slide sorting screen 326. These options include the up option 328, the down option 330, the hide option 332, and the show option 334.

Each time the up option 328 or the down option 330 is chosen, the selected image in the corresponding image box 306 ascends or descends, respectively, by one position in the overall order of images in the selected slideshow. For example, if the user of television system 100 were to select the image in the lower right hand image box 306 (3^{rd} column, 3^{rd} row), sequentially pressing the number 1 on the television remote control or control panel eight times would place the selected image in the upper left hand image box 306 (1^{st} column, 1^{st} row).

The hide option 332 allows the user to prevent the selected image from being displayed in the slideshow presentation. For example, this might be indicated by a shaded triangle in the lower left hand corner of the selected image box 306, as illustrated by region 307 in FIG. 5. The hidden image may once again be displayed in the slideshow by selecting the show option 334.

Finally, slide sorting screen 326 also includes the back option 336, which, when selected, causes the television system 100 to return to the slideshow creation screen 314 of FIG. 4.

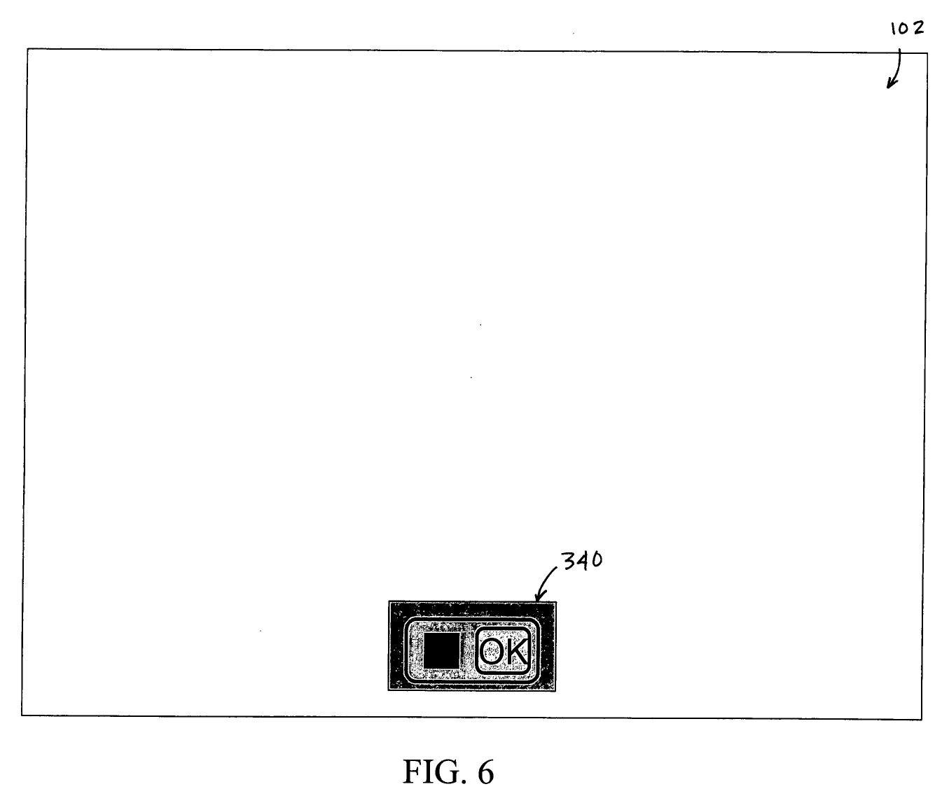

FIG. 6 illustrates a fullscreen slideshow mode of operation according to some embodiments of the invention. Fullscreen slideshow mode operation may be entered, for example, when the user of television system 100 selects the start option 304 of FIG. 3. When in this mode, the images of the selected slideshow are displayed, according to the user-entered parameters described above, on the entire LCD screen 102 of television system 100.

Also shown in the LCD screen 102 is a play controller 340. The play controller 340 is overlayed on the slideshow images. The play controller presents a visual reminder to the user of television system 100 of the appropriate touch pad or switch to depress in order to halt playback of the slideshow. For example, the play controller 340 of FIG. 4 indicates that the user of television system 100 may halt playback of the slideshow by depressing the “OK” button on the television remote control. In some embodiments of the invention, the play controller 340 only appears briefly and then disappears until the user of the television system 100 presses a button or switch on the television remote control or control panel.

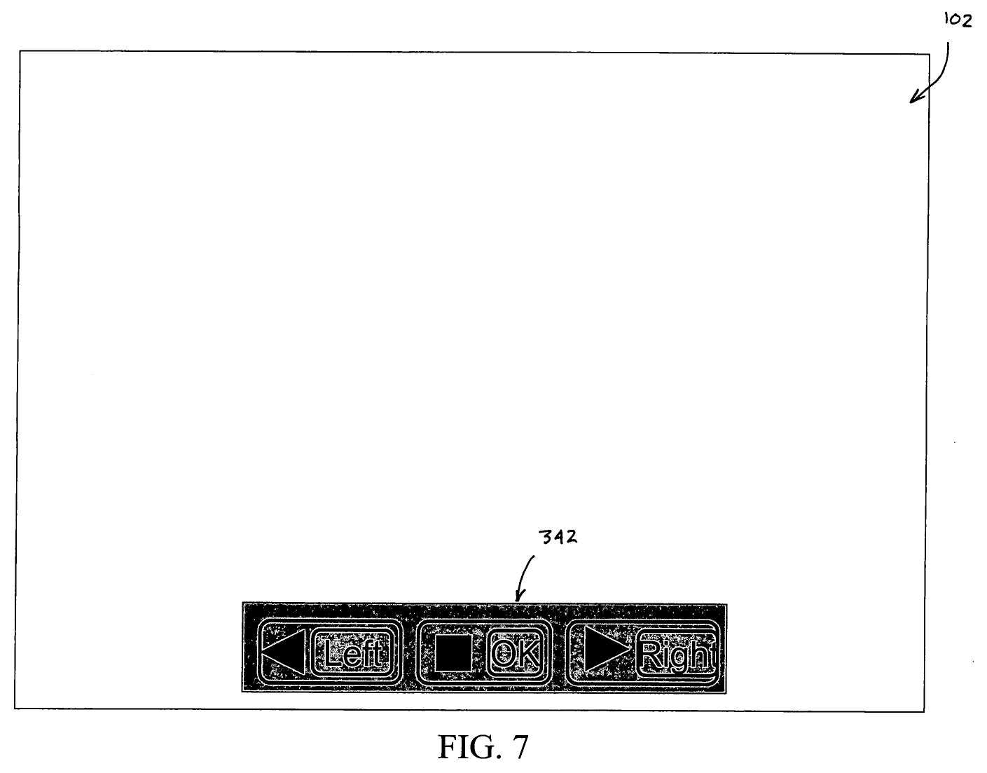

FIG. 7 illustrates a manual slideshow mode of operation according to some embodiments of the invention. Manual slideshow mode operation may be entered, for example, when the user of television system 100 selects the start option 304 of FIG. 3. When in this mode, the images of the selected slideshow are displayed, according to the user-entered parameters described above, on the entire LCD screen 102 of television system 100.

Also shown in the LCD screen 102 is a play controller 342. The play controller 342 is overlayed on the slideshow images. In manual mode, the play controller 342 presents a visual reminder to the user of television system 100 of the appropriate touch pad or switch to depress in order to advance to the next image in the slideshow, go back to the previous image in the slideshow, or stop the slideshow presentation. For example, the play controller 342 of FIG. 4 indicates that the user of television system 100 may advance to the next image in the slideshow by depressing the right arrow button on the television remote control. Likewise, the user of television system 100 may go back to the previous image in the slideshow by depressing the left arrow button on the television remote control.

In some embodiments of the invention, the play controller 342 only appears briefly and then disappears until the user of the television system 100 again presses a button or switch on the television remote control or control panel.

The embodiments of FIGS. 1-7 illustrate an apparatus and method for synchronizing digital images with digital audio for a slideshow application. One of ordinary skill in the art will recognize that the concepts taught herein can be tailored to a particular application in many other advantageous ways. In particular, those skilled in the art will recognize that the illustrated embodiments are but one of many alternative implementations that will become apparent upon reading this disclosure. There are a variety of other useful applications that are possible with the example television system 100 of FIG. 2.

For example, as explained above with reference to FIG. 2, television system 100 has the ability to output audio signals captured from by the internal microphone or a device (such as an external microphone) connected to the input jack. Using the inventive concepts explained above in reference to FIGS. 1-7, a karaoke application may be achieved with television system 100 by overlaying the captured audio signals onto a digital audio signal that is synchronized with a digital image or digital video.

Yet another example of an application that is achievable by embodiments of the invention is a storybook application. Using the inventive concepts explained above in reference to FIGS. 1-7, a storybook application may be achieved with television system 100 by recording a person's voice while he or she is reading a story out loud and synchronizing the resulting digital audio file with digital images. These images could be obtained, for example, from the storybook itself or from other sources.

Many of the specific features shown herein are design choices. The number of signal inputs, PCMCIA cards, media processors, audio processors, and options available to users of example television system 100 all merely presented as examples. Furthermore, the type, arrangement, and design of the various menu options represented in the video output of FIGS. 3-7 are also presented as examples and do not limit the invention. Such minor modifications are encompassed within the embodiments of the invention that are to be defined in the claims.

The preceding embodiments are exemplary. Although the specification may refer to “an”, “one”, “another”, or “some” embodiment(s) in several locations, this does not necessarily mean that each such reference is to the same embodiment(s), or that the feature only applies to a single embodiment.

1. A television system comprising:
a graphic user interface structured to allow a user to arrange a first digital file and a second digital file in a selected relationship, the selected relationship demonstrated when the television system outputs the first and second digital files.

2. The television system of claim 1, the first digital file and the second digital file each comprising one chosen from the group consisting of an image file, and audio file, and a video file.

3. The television system of claim 2, the graphic user interface comprising:
a display screen structured to display menu options and information pertaining to the first and second digital files;
an input device; and
a processor structured to accept signals from the input device and structured to arrange the first and second digital files in the selected relationship based upon the signals from the input device.

4. The television system of claim 3, the processor structured to arrange the image file and the audio file for simultaneous output on the television system.

5. The television system of claim 3, the processor structured to arrange the first digital file for output on the television system before the second digital file is output on the television system.

6. The television system of claim 3, the input device comprising one chosen from the group consisting of a television remote control and a touch-controlled selector located on a housing of the television system.

7. The television system of claim 3, further comprising:
an audio input selector structured to capture an audio signal; and
a speaker structured to output the audible signal while the television system outputs the content of the first and second digital files.

8. The television system of claim 7, further comprising a microphone coupled to the audio input selector.

9. A television system comprising:
a transceiver structured to wirelessly communicate with a remote device;
a memory;
a television system controller;
an output subsystem;
a processor structured to control a delay between a first data stream being output on the output subsystem and a second data stream being output on the output subsystem based upon a control signal received from the television system controller.

10. The television system of claim 9, the transceiver structured to receive the first data stream from the remote device.

11. The television system of claim 9, the memory configured to store the first data stream.

12. The television system of claim 9, the output subsystem comprising:
a display panel; and
a speaker.

13. The television system of claim 12, the display panel comprising a liquid crystal display.

14. The television system of claim 9, the remote device comprising a wi-fi router.

15. The television system of claim 9, further comprising a microphone configured to convert sounds into the first data stream.

16. The television system of claim 9, each of the first and second data streams representing one chosen from the group consisting of a digital image file, a digital music file, and a digital video file.

17. A method comprising:
creating and editing a multimedia presentation using a television; and
playing the multimedia presentation using the television.

18. The method of claim 17, wherein creating and editing comprises accessing first digital data using the television.

19. The method of claim 18, wherein accessing first digital data comprises accessing a memory device to obtain a first file chosen from the group consisting of a first digital image file, a first digital audio file, and a first digital video file.

20. The method of claim 19, wherein accessing a memory device to obtain a first file comprises wirelessly receiving the first file from a remote device.

21. The method of claim 18, wherein creating and editing further comprises accessing second digital data and synchronizing it with the first digital data.

22. The method of claim 21, wherein accessing second digital data comprises accessing a memory device to obtain a second file chosen from the group consisting of a second digital image file, a second digital audio file, and a second digital video file.

23. The method of claim 22, wherein accessing a memory device to obtain a second file comprises wirelessly receiving the second file from a remote device.

24. The method of claim 21, wherein synchronizing the first digital data with the second digital data comprises simultaneous playback of the first digital image file and the second digital audio

25. The method of claim 17, where playing the multimedia presentation comprises:
overlaying, in real time, an audio input onto the first file, the audio input selected by an input selector of the television.

26. The method of claim 25, wherein overlaying an audio input comprises overlaying a signal representing a human voice.

27. The method of claim 17, the multimedia presentation comprising one chosen from a karaoke presentation, a slideshow presentation, and a storybook presentation.
